(19) United States
(12) Patent Application Publication
(10) Pub. No.: US 2016/0167820 A1
(43) Pub. Date: Jun. 16, 2016

(54) ARTICLE-HANDLING MACHINE, MODULAR OPERATIVE GROUP, AND METHOD

(71) Applicant: SIDEL PARTICIPATIONS S.A.S., Octeville-sur-Mer (FR)

(72) Inventors: Davide UGOLINI, Parma (IT); Stefano MOLINARI, Parma (IT)

(73) Assignee: SIDEL PARTICIPATIONS S.A.S.

(21) Appl. No.: 14/956,981

(22) Filed: Dec. 2, 2015

(30) Foreign Application Priority Data
Dec. 12, 2014 (EP) 14197826.2

(51) Int. Cl. B65C 9/04; B65G 29/00

(52) U.S. Cl. CPC B65C 9/04; B65G 29/00

(57) ABSTRACT

An article-handling machine for carrying out an operation on an article is disclosed. The article-handling machine includes a carousel configured to convey the article along a path. The carousel includes one of at least one seat or at least one pin. The article-handling machine further includes a modular operative group configured to carry out the operation on the article. The modular operative group includes the other one of at least one seat or at least one pin. The at least one pin is configured to engage the at least one seat, so as to dock the modular operative group to the carousel. The article-handling machine further includes at least one constraining assembly for constraining the at least one pin inside the at least one seat. The constraining assembly is configured to move towards and away from the at least one seat between a rest configuration and an operative configuration.

The present invention relates to an article-handling machine for carrying out an operation on a plurality of articles, to a modular operative group, and to a method of docking a modular operative group to an article-handling machine.

In particular, the article-handling machine is a labelling machine for applying a plurality of labels onto respective containers filled with a pourable food product,

Labelling machines are known, which substantially comprise:

a rotary carousel, which is fed with articles to be labelled at an input station, conveys that articles along an arch-shaped path, and outputs the labelled articles to an output station; and

a plurality of modular labelling groups, which are arranged at the outer periphery of the carousel and which feed and apply a plurality of labels onto respective articles at respective application stations arranged on the arch-shaped path.

Labelling machine is known as “roll-feed”, in which each modular labelling group substantially comprises, each,:

a frame, which rests on the floor and is docked to the carousel;

a shaft for rotatably supporting a reel off which a strip of labels is unwound and fed along a feed path;

a plurality of unwinding rollers for guiding the strip along a rectilinear feed path;

a cutter for cutting a sequence of single labels from the strip;

a transfer drum for advancing each label which has been previously cut; and

a gluing drum for applying glue onto each previously cut label.

In particular, a conventional transfer drum is rotatable about an axis, comprises an outer surface which receives a succession of cut labels and covered with glue, and releases those labels at respective application station after rotation about its own axis of a certain angle.

The transfer drum conveys the labels tangentially to the outer surface of the articles and to be labelled, at the application station.

The frame supports the shaft, the unwinding rollers, the transfer drum and the gluing drum.

The carousel further comprises an interface area for the docking to the modular labelling group.

The interface area comprises a pair of seats, which are angularly spaced from one another and are engaged by corresponding pins carried by the modular labelling group, when the latter is docked to the carousel.

Still more precisely, the operator:

moves the modular operative group on a trans-pallet up to reach a position close to the carousel;

lowers the trans-pallet up to when the pins engage the relative seats and the modular labelling group is supported by relative support elements, so as to dock the modular labelling group to the carousel; and

then moves away from the carousel the trans-pallet without the modular labelling group thereon.

Though performing excellently on the whole, the labelling machine of the type described still leave room for further improvement.

As a matter of fact, the Applicant has found that during the operation of the labelling machine, the inevitable vibrations generated by the operation of the labelling group inevitably result in the movement of the pins with respect to the relative seats.

As a consequence, the modular operative group slightly moves with respect to the carousel in comparison with its theoretical operative position, thus inevitably affecting the final precision and repeatibility in the application of the labels to the articles.

Furthermore, in certain embodiments, the labelling group is particularly unbalanced and non-symmetrical. Even, the barycentre of the labelling group can be arranged outside the frame.

In this case, the precise and repeatable positioning of both the pins inside relative seats is really difficult for the operator and there is the risk that one of the pins is not precisely inserted in the relative seat.

As a result, either the labelling machine is prevented from operating due to the detection of a not proper docking of the modular labelling group or the error in the mutual positioning of the modular labelling group and the carousel inevitably affects the final the final precision and repeatibility in the application of the labels to the articles.

Finally, in case that the floor is not even, once docked to the carousel, the modular labelling group is set in a position different from the theoretical one assumed in case of even floor.

As a result, also in this case, the final precision and repeatibility in the application of the labels to the articles would be affected.

It is an object of the present invention to provide an article-handling machine, designed to eliminate at least one of the above-identified drawbacks in a straightforward and low-cost manner.

According to the present invention, there is provided an article-handling machine for carrying out an operation on an article, as claimed in claim 1.

The present invention also relates to a modular operative group for carrying out an operation on an article, as claimed in claim 13.

The present invention also relates to a method of docking a modular operative group to a carousel of an article-handling machine, as claimed in claim 15.

In the following one preferred, non-limiting embodiment of the present invention will be described by way of example with reference to the accompanying drawings, in which:

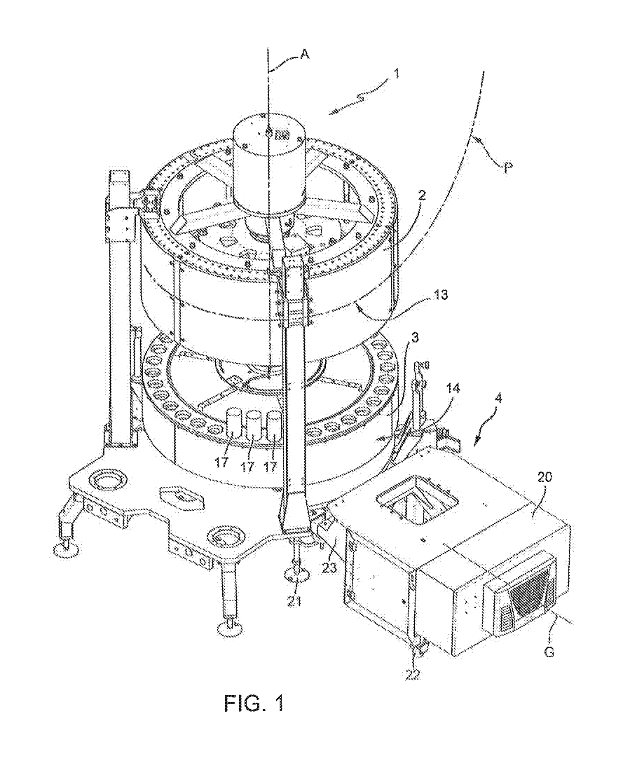

FIG. 1 is a perspective view of an article-handling machine, in particular a labelling machine, for carrying out an operation, in particular a labelling operation, onto a plurality of articles, according to the present invention;

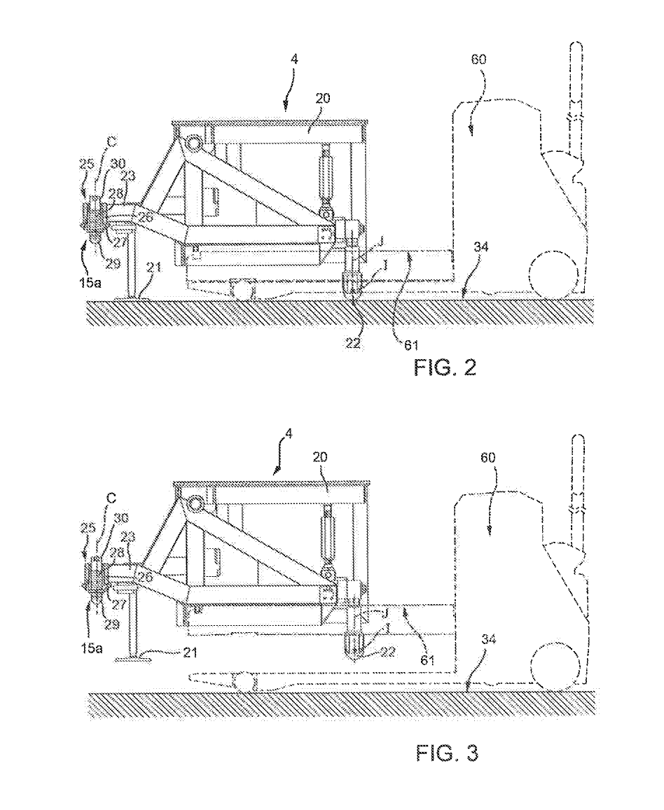

FIGS. 2 to 7 show respective subsequent operative steps of the docking of a modular operative group to the carousel of the article-handling machine of FIG. 1;

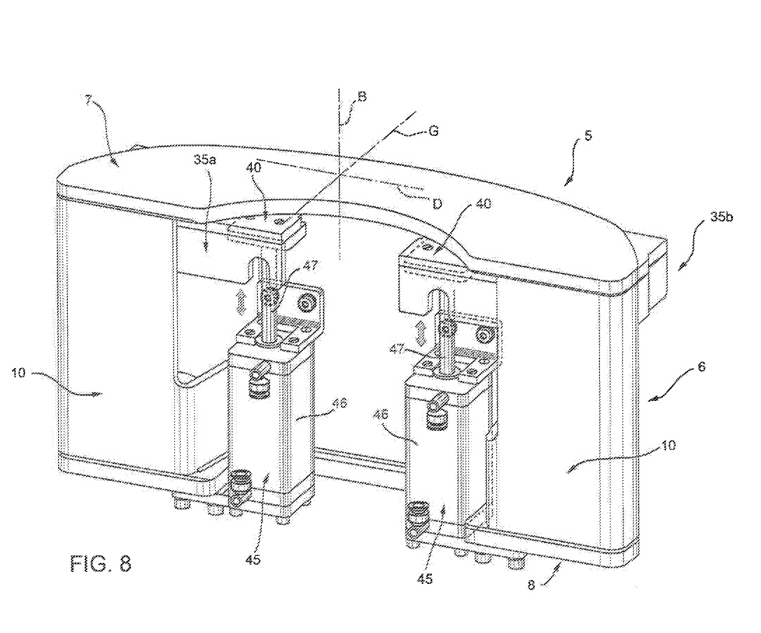

FIG. 8 shows, in a perspective view, first components of the article-handling machine of FIGS. 1 to 7, with parts removed for clarity and from a first visual angle;

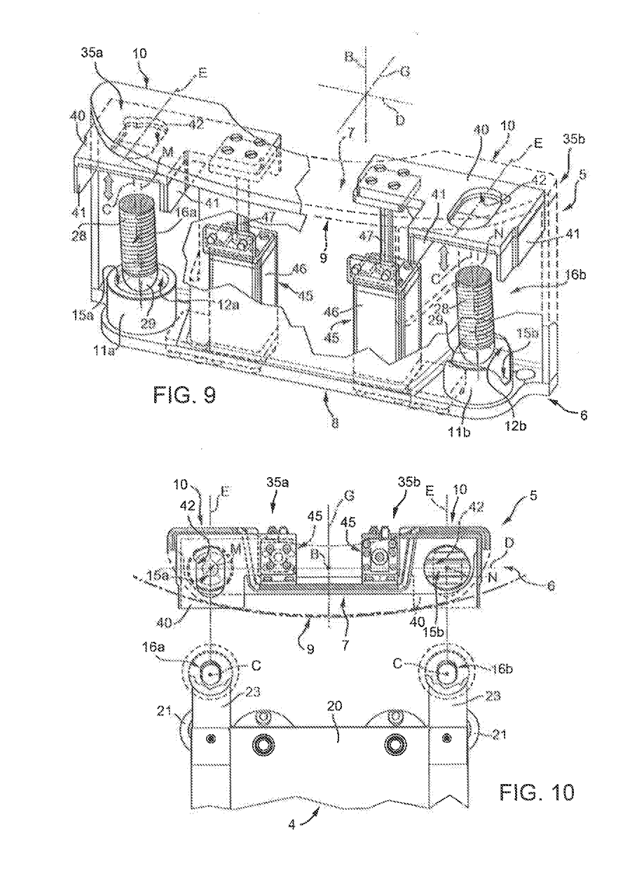

FIG. 9 shows, in a perspective view, second components of the article-handling machine of FIGS. 1 to 7, with parts removed for clarity and from a second visual angle; and

FIG. 10 is a top view of the second components of FIG. 9,

Number 1 in FIG. 1 indicates as a whole a labelling machine for applying labels (not-shown) to respective articles 17, containers for pourable food product in the embodiment shown.

In particular, labelling machine 1 is a so-called “roll-fed” labelling machine.

Labelling machine 1 substantially comprises (FIG. 1);

a stator 2;

a carousel 3, which rotates about an axis A, vertical in use, with respect to stator 2, and advances a succession of spaced articles 17 along an axe-shaped path P;

a plurality of modular labelling groups 4 (only one of which is shown in FIG. 1), which are arranged on the periphery of carousel 3.

Carousel 3 comprises a radially outer periphery 14 with respect to axis A.

Furthermore, it is possible to identify a direction C, which is radial with respect to axis A.

Carousel 3 comprises, for each labelling group 4, respective interface module 5 at which each labelling group 4 is docked to carousel 3.

In the embodiment shown, interface modules 5 are arranged radially inner with respect to periphery 14.

In the following of the present description, only one labelling group 4 and the corresponding interface module 5 will be described, being all labelling groups 4 and interface modules 5 identical to one another.

In detail, interface module 5 comprises two seats 15a, 15b (FIG. 9), which are engaged by respective pins 16a, 16b carried by labelling group 4 when the latter is in the docking position.

Still more precisely, interface module 5 comprises (FIGS. 9 and 10) a frame 6 which is fixed to carousel 3.

It is possible to associate to interface module 5

an axis B, parallel to axis A and orthogonal to direction G; and

an axis D, orthogonal to axis B and direction G.

Axes A, B are vertical, and axis B and direction G are horizontal in the embodiment shown.

Frame 6 comprises (FIGS. 8 to 10):

a top wall 7, which lies on a plane orthogonal to axis A;

a bottom wall 8, which is parallel to and spaced from wall 7 along axis B;

a front all 9, which is interposed between walls 7, 8 on the opposite side of axis A; and

a pair of rear walls 10, which are opposite to wall 9 along direction B and are arranged radially inner with respect to wall 9.

Walls 10 are aligned with one another parallel to axis D.

In the embodiment shown, wall 7 is shaped as a portion of a circular crown having the centre on axis A and wall 9 is shaped as a portion of cylinder of axis A.

Frame 6 further comprises a pair of bodies 11a, 11b, which are spaced along axis D and protrude from wall 8 towards wall 7.

Bodies 11a, 11b define respectively seats 15a, 15b.

With reference to FIG. 9, body 11a is a hollow cylinder, which extends about an axis N parallel to axis B.

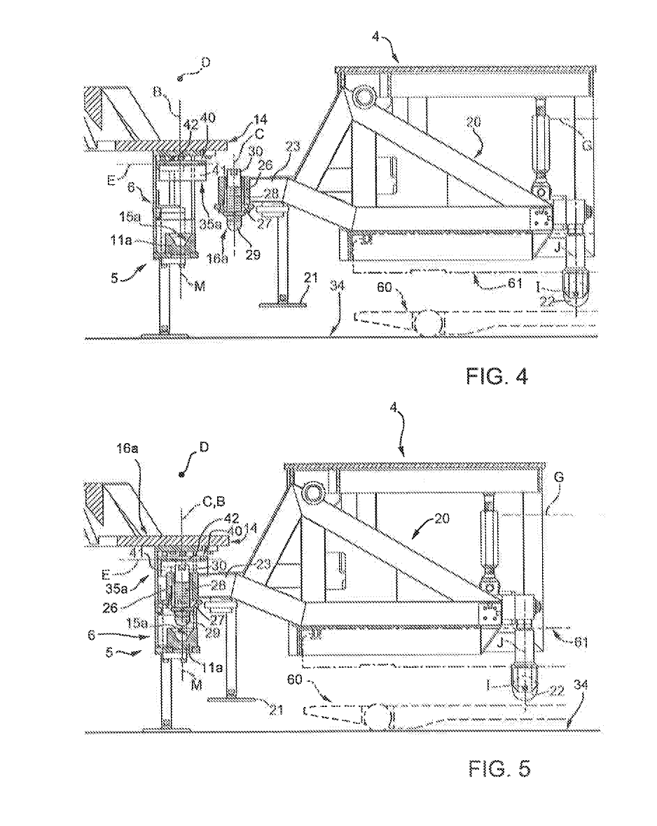

Seat 15a is conical about axis M and tapers on the opposite side of wall 9 (FIGS. 4 to 7), i.e. towards wall 8.

Furthermore, seat 15a is bounded by inner wall 12a of body 11a.

Body 11b is shaped as a cylinder of axis N, parallel to axis M. Body 11b is relieved along axis D.

Seat 15b is therefore conical about N and relieved about axis D.

Axes M, N are vertical in the embodiment shown.

Seat 15b is therefore closed parallel to direction G and bounded by inner wall 12b of body 11b and open parallel to axis D.

In the following of the description, the expression “frontward”, “rearward”, “lateral”, “top”, “bottom” refer to the position of the labelling group 4 with respect of carousel 3.

Labelling group 4 is of the type described in EP2580130 in the name of the same Applicant.

Labelling group 4 substantially comprises:

a pair of shafts for rotatably supporting relative reels (off which a strip of labels is unwound and fed along a feed an application station 13 shown only in FIG. 1);

a plurality of unwinding rollers for guiding strip along the feed path;

a cutting element (not-shown) for cutting, one after the other, labels from the strip;

a glue roller for applying glue onto cut labels; and

a transfer element for transferring cut and glue-covered labels along an arc-shaped trajectory to application station 13.

Labelling group 4 comprises, in turn, (FIGS. 1 to 7:

a frame 20, which supports the shafts, the rollers, the glue roller and the transfer element;

a pair of frontward pedestals which downwardly protrude from frame 20; and

a pair of rearward wheels 22, which downwardly protrude from frame 20.

Labelling group 4 further comprises a pair of arms 23 which frontally protrude from frame 20.

Each arm 23 supports, at end 25 (FIGS. 2 and 3) thereof, a cylindrical body 26, which extends about an axis C.

Each arm 23 further comprises a sleeve 27 (FIGS. 2 and 7) coaxially housed inside a relative body 26 and firmly connected to relative body 26.

Sleeves 27 coaxially houses relative pins 16a, 16b.

Furthermore, the radially inner surface of sleeve 27 is partially screwed and engaged by a screw portion of relative pin 16a, 16b.

In other words, pins 16a, 16b are coaxially housed inside sleeves 27 which are, in turn, coaxially housed inside relative bodies 26.

Each pin 16a, 16b comprises

an axial end 30, a top end in the embodiment shown;

a stem 28, which is housed inside body 26 with radial gap with respect to axis C and is screwed to relative sleeve 27; and

a head 29, which defines an axial end opposite to end 30, a bottom end in the embodiment shown, of stem 28 and is adapted to engage relative seat 15a, 15b.

Head 29 is shaped as a portion of a sphere.

Advantageously, labelling machine 1 comprises a pair of constraining assembly 35a, 35b for constraining respective pins 16a, 16b inside relative seats 15a, 15b; each constraining assembly 35a, 35b is movable along a relative axes B towards and away from relative pin 16a, 16b between;

a relative rest configuration (FIGS. 3 to 6), in which it is detached from relative pin 16a, 16b engaging relative seat 15a, 15b; and

a relative operative configuration (FIG. 7), in which it cooperates with relative pin 16a, 16b engaging relative seat 15a, 15b, so as to constrain relative pin 16a, 16b inside relative seat 15a, 15b.

In this way, constraining assemblies 35a, 35b, when set in relative operative configuration, keep relative pins 16a, 16b inside seats 15a, 15b, thus firmly keeping labelling group 4 in the docking position.

Constraining assemblies 35a, 35b are spaced apart from one another parallel to axis D (FIGS. 8 to 10).

In greater detail, each constraining assembly 35a, 35b contacts relative sleeve 27 housing relative pin 16a, 16b, when it is set in the relative operative configuration (FIG. 7).

Furthermore, each constraining assembly 35a, 35b is spaced from relative sleeve 27 parallel to axis B, when it is set in the relative rest configuration.

In the embodiment shown, constraining assemblies 35a, 35b are carried by carousel 3.

In greater detail, constraining assemblies 35a, 35b are housed inside frame 6 of interface module 5.

More precisely, each constraining assembly 35a, 35b comprises:

an abetting plate 40, which lies on a plane orthogonal to axis B; and

a pair of appendices 41, which protrude parallel to one another from plate 40 towards relative seat 15a, 15b.

In the embodiment shown, appendices 41 lies on respective planes orthogonal to axis D, are parallel to one another and spaced parallel to axis D.

Furthermore, each plate 40 defines a slot 42 which, is aligned with relative seats 15a, 15b parallel to respective axes M, N, and with pins 16a, 16b, parallel to respective axes C, when pins 16a, 16b engage relative seats 15a, 15b.

Each slot 42 has a width parallel to relative axis and a length parallel to a relative axis E, orthogonal to axis B and D (FIGS. 9 and 10).

Axes E are horizontal, in the embodiment shown.

The length of slot 42 is greater than the width of same slot 42.

When each constraining assembly 35a, 35b is in relative rest configuration (FIGS. 3 to 6), plate 40 and appendices 41 are in respective operative and raised positions with respect to axis B.

When each constraining assembly 35a, 35b is in relative operative configuration (FIG. 7), plate 40 and appendices 41 are in respective rest and lowered positions with respect to axis B.

When plate 40 of each constraining assembly 35a, 35b is in the relative rest and raised position, it is axially spaced along relative axis M, N from relative seat 15a, 15b.

When plate 40 of each constraining assembly 35a, 35b is in the relative rest and raised position, it is axially spaced and from relative pin 16a, 16b parallel to relative axes C, when relative pin 16a, 16b engages relative seat 15a, 15b.

Furthermore, relative slot 42 is disengaged and spaced apart from relative pin 16a, 16b parallel to axis B.

When, each plate 40 is in relative operative position, it abuts against and presses end 26 of relative pin 16a, 16b towards relative seat 15a, 15b.

As a result, pins 16a, 16b are subjected to relative axial actions parallel to axes D and constrained inside relative seats 15a, 15b.

In the embodiment shown, the rest position of plates 40 and appendices 41 are lowered parallel to axis B with respect to the operative position thereof.

Furthermore, each constraining assembly 35a, 35b comprises an actuator 45 (FIG. 8) for moving relative plate 40 between the relative rest and raised position and the relative lowered and operative position.

In greater detail, actuators 45 are arranged between seats 15a, 15b along axis D.

Each actuator 45 comprises, in turn,:

a housing 46 fitted to wall 8 of frame 6; and

a piston 47, which protrudes from housing 46 towards wall 7, is slidable parallel to relative axis A, B, M, N with respect to housing 46 and is connected to housing 46.

Housing 46 comprises not-shown control means for moving piston 47 parallel to relative axis A, B, M and N.

Control means can be electrically, pneumatically or hydraulically operated.

Labelling group 4 can be arranged in:

a stored position (FIG. 2), in which pedestals 21 and wheels 22 rest on floor 34; and

the docking position (FIG. 7), in which pedestals 21 are raised from floor 34 and wheels 22 rest on floor 34.

As evident from FIGS. 2 and 3, labelling group 4 is picked by a trans-pallet 60 in the stored position and arranged in the docking position.

Wheels 22 have respective rotation axes I and can be tilted about an axis J between:

respective first annular positions (FIGS. 2 to 6); and

respective second angular positions (FIG. 7), in which they lie on a plane orthogonal to direction G.

Axis J is parallel to axis C and orthogonal to floor 34, when labelling group 4 is in the stored position.

Wheels 22 are in the respective first positions, when labelling group 4 is in the stored position.

Wheels 22 are in the respective second positions, when labelling group 4 is in the docking position.

It is important to point out that wheels 22 are not used for causing the rolling of labelling group 4 on floor 34 from the transport position to the docking position.

Alternatively, labelling group 4 could comprise a pair of spheres instead of wheels 22.

The docking of labelling groups 4 to carousel 3 is described with reference to only one labelling group 4 and relative interface module 5, and starting from a condition (FIG. 2), in which constraining assemblies 35a, 35b are in respective rest configurations and labelling group 4 is in the stored position, with wheels 22 and pedestal 21 rest on a floor 34.

In this situation, wheels 22 are in respective first angular positions.

At this stage, a movable plane 61 of trans-pallet 60 is inserted below frame 20 and is raised orthogonally to floor 34, so as to raise frame 20, wheels 22, pedestals 21 and whole labelling group 4 from floor 34 (FIG. 3).

Trans-pallet 60 approaches labelling group 4 to the interface module 5 of carousel 3 (FIG. 4), up to reach a position in which axes C of pin 16a, 16b are aligned with relative axes M, N of respective seats 15a, 15b (FIG. 5).

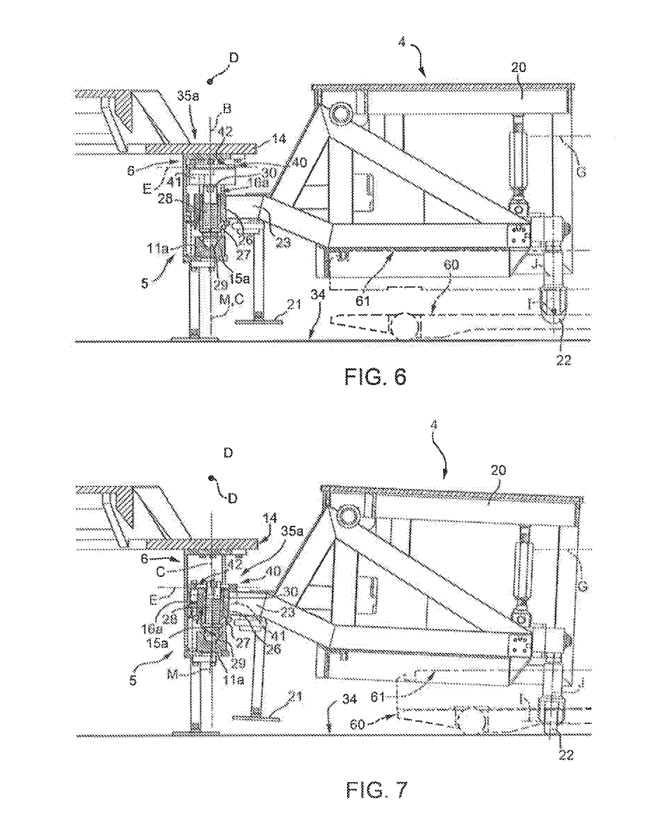

Movable plane 61 is then lowered towards floor 34, so as to engage pins 16a, 16b inside respective seats 15a, 15b, with pedestals 21 and wheel 22 still raised with respect to floor 34 (FIG. 6).

Due to the fact that constraining assemblies 35a, 35b are in the respective rest configurations, plates 40 do not interfere with the positioning of pins 16a, 16b inside seats 15a, 15b.

Afterwards, plane 61 is completely lowered with respect to floor 60 and trans-pallet 60 is moved away from carousel 3.

Due to the fact that pins 16a, 16b engage relative seats 15a, 15b, labelling group 4 remains inclined with pedestals 21 raised from floor 34 and wheels 22 on floor 34 (FIG. 7).

In the meanwhile, constraining assemblies 35a, 35b simultaneously move from the relative rest configurations to the relative operative configurations, in which they constrain pins 16a, 16b inside relative seats 15a, 15b (FIG. 7), and wheels 22 are rotated from respective first angular positions to respective second angular positions.

In greater detail, plates 40 simultaneously move along axis B from:

the relative rest positions, in which they are spaced along axis B from pins 16a, 16b engaging seats 15a, 15b; to

the relative operative positions, in which they abut against sleeve 27 and press pins 16a, 16b inside seats 15a, 15b parallel to axis B.

Accordingly, pins 16a, 16b are constrained inside seats 15a, 15b.

Thanks to the fact that wheels 22 are arranged in the respective second angular positions, labelling group 4 can slightly rotate about axis A and with respect to carousel 3.

Accordingly, pins 16a, 16b can slightly adjust the position of relative axes C its position with respect to axes M, N of corresponding seats 15a, 15b (FIG. 7), up to when both pins 16a, 16b are firmly housed inside relative seats 15a, 15b.

At this stage, labelling group 4 is firmly docked with respect to carousel 3 and labelling machine 1 can properly operate.

From an analysis of the features of labelling machine 1, modular labels it group 4 and method made according to the present invention, the advantages it allows to obtain are apparent.

In particular, labelling machine 1 comprises constraining assemblies 35a, 35b movable between:

a rest configuration, in which they are detached from pins 16a, 16b engaging relative seats 15a, 15b; and

an operative configuration, in which they cooperate with pins 16a, 16b engaging relative seats 15a, 15b.

Accordingly, constraining assemblies 35a, 35b constrain pins 16a, 16b inside seats 15a, 15b.

As a result of this constrain action, pins 16a, 16b are more firmly kept in their theoretical positions inside seats 15a, 15b, when compared with the known solutions described in the introductory part of the present description.

Therefore, the vibrations generated by the operation of labelling group 4 are less likely to cause a movement of pins 16a, 16b inside respective seats 15a, 15b.

Accordingly, the final precision and repeatibility in the application position of the labels onto articles 17 is enhanced.

Furthermore,the constraining action of constraining assemblies 35a, 35b ensure a proper positioning of pins 16a, 16b inside relative seats 15a, 15b also in case of unbalanced and non-symmetrical labelling group 4.

As a consequence, it is dramatically reduced the risk that a not proper docking of labelling group 4 to carousel 3 could either preventing labelling machine 1 from operating or affect the final precision and repeatibility in the application of labels to articles 17.

Also in case floor 34 is not even, constraining assembly 35a, 35b contribute to arrange labelling group 4 very close to the theoretical position thereof assumed in case of even floor.

As a result, also in this case, the final precision and repeatibility in the application of labels onto relative articles 17 is enhanced in comparison with the known solution described in the introductory part of the present description.

Finally, wheels 22 set in the respective second angular position or not-shown spheres of labelling group 4 allow the latter to slightly rotate about axis A, when labelling group 4 is in the clocking position and constraining assemblies 35a, 35b are in the operative configuration.

Accordingly, pin 16b can perfectly centre itself inside seat 16b , thus ensuring higher degree of precision and repeatibility in the application of labels onto relative articles 17.

Finally, is apparent that modifications and variants not departing from the scope of protection of the claims may be made to labelling machine 1, modular labelling group 4 and to the method.

In particular, modular labelling group 4 could be adapted to carry out an operation, other than labelling, onto articles 17, e,g, a blowing, rinsing, filling or capping operation.

Furthermore, seats 15a, 15b could be carried by labelling group 4 and pins 16a, 16b could be carried by interface module 5 of carousel 3.

Constraining assemblies 35a, 35b could be carried by labelling group 4 instead of interface 5 of carousel 3.

Labelling machine 1 could comprise only one constraining assembly 35a, 35b.

1. An article-handling machine for carrying out an operation on an article, comprising:
a carousel configured to rotate about a first axis and to convey the article along a path, the carousel comprising one of at least one seat or at least one pin: and
a modular operative group configured to carry out the operation on the article, the modular operative group comprising the other one of at least one seat or at least one pin, wherein the at least one pin is configured to engage the at least one seat, so as to dock the modular operative group to the carousel;
at least one constraining assembly for constraining the at least one pin inside the at least one seat;
wherein the constraining assembly is configured to move towards and away from the at least one seat between:
a rest configuration, in which the constrain n assembly is detached from the at least one pin engaging the at least one seat; and
an operative configuration, in which the constraining assembly cooperates with the at least one pin engaging the at least one seat, so as to constrain the at least one pin inside the at least one seat.

2. The article-handling machine of claim 1, further comprising at least one sleeve surrounding the at least one pin.

3. The article-handling machine of claim 2, wherein the constraining assembly contacts the at least one sleeve and is detached from the at least one pin, when the constraining assembly is in the operative configuration.

4. The article-handling machine of claim 3, wherein the constraining assembly comprises:
a plate lying on a plane transversal to a second axis, which is parallel to the first axis and defining a through slot, which is parallel to the second axis;
wherein the slot is engaged by the at least one pin and the plate contacts the at least one sleeve, when the constraining assembly is in the operative configuration.

5. The article-handling machine of claim 4, wherein the constraining assembly comprises an actuator configured to move the plate parallel to the second axis;
wherein the actuator includes:
a body fixed to the carousel with respect to the second axis; and
a piston, which protrudes from the body, is movable with respect to the body parallel to the second axis, and is connected to the plate.

6. The article-handling machine of claim 5, wherein the constraining assembly comprises a pair of appendices protruding from the plate, wherein the actuator is arranged on only one side of the pair of appendices.

7. The article-handling machine of claim 1, wherein the at least one seat includes a pair of seats, which are spaced apart from each other in a direction traversal to the first axis;
wherein the article-handling machine further comprises a pair of corresponding constraining assemblies, which are independently movable towards and away from the corresponding seats.

8. The article-handling machine of claim 7, wherein one of the pair of seats is conical along a third axis and the other one of the pair of seats is open tangentially to a fourth axis transversal to the third axis.

9. The article-handling machine of claim 1, wherein at least one of the following occurs:
the constraining assembly is carried by the carousel;
the modular operative group carries the at least one pin; or
the carousel carries the at least one seat.

10. The article-handling machine of claim 1 wherein the constraining assembly is arranged radially inwards from the outer periphery of the carousel with respect to the axis.

11. The article-handling machine of claim 1 wherein the modular operative group comprises at least one support device configured to rest on a floor and to allow a position of the modular operative group to be adjusted tangentially to the first axis, when the modular operative group is docked to the carousel.

12. The article-handling machine of claim 11, wherein the at least one support device includes at least one sphere or at least one wheel;
wherein the at least one support device is rotatable between:
a transport position, which is assumed during the transport of the modular operative group; and
a docking position, in which the at least one support device lies on a plane transversal to a direction radial with respect to the first axis and is assumed when the at least one pin engages the at least one seat. (15a, 15b).

13. A modular operative group for carrying out an operation on an article, comprising:
at least one pin configured to engage at least one seat, which is defined by a carousel of an article-handling machine, so as to dock the modular operative group to the carousel; and
at least one support device configured to adjust a position of the modular operative group tangentially to a first axis, when the at least one pin engages the at least one seat.

14. The modular operative group of claim 13, wherein the at least one support device comprises at least one sphere or at least one wheel;
wherein the at least one support device is rotatable with respect to a second axis parallel to the first axis between:
a transport position, which is assumed during the transport of the modular operative group; and
a docking position, in which the at least one support device lies on a plane transversal to a direction radial with respect to the first axis and is assumed when the at least one pin engages the at least one seat.

15. A method of docking a modular operative group to an article-handling machine, the modular operative group being configured to carry out an operation onto a plurality of articles advanced by a carousel of the article-handling machine; the method comprising
engaging at least one pin carried by one of the modular operative group or the carousel with at least one seat carried by the other of the modular operative group or the carousel, so as to dock the modular operative group to the carousel:
moving at least one constraining assembly between:
a rest configuration, in which the at least one constraining assembly is detached from the at least one pin engaging the at least one seat; and
an operative configuration, in which the at least one constraining assembly cooperates with the at least one pin engaging the at least one seat.

16. The method of claim 15, further comprising arranging at least one support device of the modular operative group on a floor and in a position in which the at least one support device allows the modular operative group to adjust its position tangentially to an axis of said the carousel, when the modular operative group is docked to the carousel.

17. The method of claim 16, further comprising:
keeping the at least one support device spaced apart from the floor when engaging the at least one pin with the at least one seat;
arranging the at least one support device on the floor moving the at least one constraining assembly between the rest configuration and the operative configuration and when said constraining assembly is in the operative configuration.
